(19) United States
(12) Patent Application Publication
(10) Pub. No.: US 2014/0262694 A1
(43) Pub. Date: Sep. 18, 2014

(54) CONVEYOR HAVING A CATENARY IN THE RETURN PATH

(71) Applicant: INTERROLL HOLDING AG, Sant Antonino (CH)

(72) Inventor: Darrell Keith Knigge, Wetmore, CO (US)

(73) Assignee: INTERROLL HOLDING AG, Sant Antonino (CH)

(21) Appl. No.: 13/842,090

(22) Filed: Mar. 15, 2013

(51) Int. Cl. B65G 15/02

(52) U.S. Cl. CPC B65G 15/02
USPC 198/831

(57) ABSTRACT

Curved conveyors are disclosed herein. An embodiment of a curved conveyor includes a first end and a second end. Items to be conveyed are received onto the conveyor at the first end and the items to be conveyed are removed from the conveyor at the second end. The conveyor forms an arc between the first end and the second end. A continuous belt rotates between the first end and the second end along the arc of the curved conveyor. The belt has a forward path during its travel from the first end to the second end and a return path during its travel from the second end to the first end. A chain is attached to the belt wherein the chain forms a catenary in at least a portion of the return path.

### BACKGROUND

Curved belt conveyors change the direction in which items are conveyed. For example, items being conveyed in a first direction are deposited onto a belt, the items exit the conveyor a second direction. Moving the belt of a curved conveyor can be rather difficult. The nature of a curved conveyor does not allow for conventional pulleys and/or rollers to be used because conventional pulleys and rollers rely on friction to move the belt. More specifically, the nature of the curve causes the belt to be somewhat conical in shape. The conical shape does not enable frictional force between conventional rollers and pulleys because the belt would slide off the rollers and pulleys.

Many curved conveyors use a chain attached to the belt to provide movement of the belt. The belt and chain are in a forward path during the portion of travel when items are being conveyed, this is usually when the belt and chain are on the top of the conveyor. The belt and chain are in the return path or take up when they are in the portion of the conveyor where items are not being conveyed. This is usually when the belt and chain are on the underside of the conveyor. Rollers are placed on the ends of the conveyor to transition the belt and/or chain between the forward and the return paths.

The chain is attached to an edge of the belt, so they both must follow the curve of the belt in both the return path and the forward path. The chain is in or follows a guide in the forward path so that the belt will follow the forward path. In the return path, the chain is in a guide or the like so that it follows the curve of the return path. The rollers located at the ends of the conveyor are moved relative to each other in order to loosen or tighten the chain. If the chain is too loose, it may not stay in the chain guides. If the chain is too tight, it will wear or it will cause other components in the conveyor to wear prematurely.

### SUMMARY

Curved conveyors are disclosed herein. An embodiment of a curved conveyor includes a first end and a second end. Items to be conveyed are received onto the conveyor at the first end and the items to be conveyed are removed from the conveyor at the second end. The conveyor forms an arc between the first end and the second end. A continuous belt rotates between the first end and the second end along the arc of the curved conveyor. The belt has a forward path during its travel from the first end to the second end and a return path during its travel from the second end to the first end. A chain is attached to the belt wherein the chain forms a catenary in at least a portion of the return path.

### BRIEF DESCRIPTION OF THE DRAWINGS

FIG. 1 is a top isometric view of a prior art conveyor.

FIG. 2 is a side elevation view of the conveyor of FIG. 1.

FIG. 3 is a top perspective view of an embodiment of a conveyor.

FIG. 4 is a top plan view of the conveyor of FIG. 3.

FIGS. 5A-5D are side elevation views of the conveyor of FIG. 3 using different embodiments of catenaries.

### DETAILED DESCRIPTION

Curved conveyors are disclosed herein. The conveyors move items on a curved belt wherein the belt is driven or moved by a chain. FIG. 1 is a top isometric view of a prior art conveyor 100 and FIG. 2 is a side elevation view of the conveyor 100. The conveyor 100 uses a chain 102 to move a belt 106. The belt 106 is mechanically connected to the chain 102 so that the belt 106 moves when the chain 102 moves. A conventional sprocket or other mechanism may be used to move the chain 102. The chain 102 and the belt 112 have a forward path 108 and a return or take up path 110. The forward path, in the embodiments of FIGS. 1 and 2, corresponds to the top portion of the conveyor 100 that is used to convey items. The return path 110 is typically the portion of the path that is under the conveyor 100.

The conventional conveyors 100 use a chain guide 112 (not shown in FIG. 1) or other mechanism in the return path 110 to guide the chain 102. The chain guide 112 serves to guide the chain 102 along the arc or curve in the return path 110. As shown in FIGS. 1 and 2, the chain 102 in the return path 110 is substantially straight because it is kept in the chain guide 112. The chain 102 moves around sprockets 116, 118 as it transitions between the forward path 108 and the return path 110. In some conveyors, one or both sprockets 116, 118 are moveable in order to adjust the tension on the chain 102 and/or the belt 106. The conveyors disclosed herein tension the chain by means other than moving the sprockets.

A top perspective view of an embodiment of a conveyor 200 that uses a catenary 202 on the return path or take up path of a chain 204 is shown in FIG. 3. A top plan view of the conveyor 200 is shown in FIG. 4. The conveyor 200 moves items by way of a continuous belt 206. The belt 206 extends between a first end 210 and a second end 212 of the conveyor 200. The conveyor 200 is referred to as having an upper side 216 and a lower side 218. The portion of the belt 206 traveling in the upper side 216 is referred to as being in the forward path and the portion of the belt 206 traveling in the lower side 218 is referred to as being in the return path. The conveyor 200 functions by conveying items on the belt 206 from the first end 210 to the second end 212 or during the forward path of the belt 206.

As shown in FIG. 4, the conveyor 200 forms an arc having an radius R that extends to an outside edge 220 of the conveyor 200. The chain 204 is attached to the belt 206 proximate the outside edge 220. The chain 204 must follow the arc in both the return path and the forward path because it is attached to the belt 206. As described above, chains in conventional curved conveyors are placed in guides to guide them in the arced forward and return paths. The guides have been used because the consensus in the prior art is that the chains would not follow the arc of the return and forward paths. The consensus was that the chains tend to follow a straight line and would distort or wear the belt if they were not maintained in a guide. The chains on conventional conveyors are tightened by moving rollers at the ends of the conveyor.

The conveyor 200 disclosed herein does not use a guide extending the entire length of the return path for the chain 204. In addition, the chain 204 does not have to be tightened as with conventional conveyors. The conveyor 200 uses at least one catenary 202 in the return path of the chain 204. The catenary 202 is a portion of the chain 204 in the return path that sags due to its own weight. The weight of the sagging chain 204 in the catenary 202 provides enough force on the chain 204 to keep it tight during the operation of the conveyor 200. The term catenary means a portion of the chain 204 that sags under its own weight. The chain 204 is tight enough to operate in the conveyor 200 if it is tight enough to operate in sprockets or the like that move the chain 204. The applicants have found that the catenary 202 described herein enables the chain 204 to follow the arc of the conveyor 200 rather than travel in a straight line as conventional catenaries do. By following the arc of the conveyor 200, the chain 204 does not cause excessive wear on the belt 206 or any sprockets or the like that move the chain 204.

Having summarily described the conveyor 200 and the catenaries 202, they will now be described in greater detail below. Reference is made to FIGS. 5A-5D, which are side views of different conveyors using different embodiments of catenaries. FIG. 5A shows a conveyor 230 having a powered sprocket 232 and a take up sprocket 234. The take up sprocket 234 is located proximate the first end 236 of the conveyor 230 and the powered sprocket 232 is located proximate the second end 238 of the conveyor 230. A chain 240 wraps around the sprockets 232, 234 so as to be moved by the sprockets 232, 234. More specifically, the powered sprocket 232 pulls the chain 240 so that the forward path of the chain 240 is from the take-up sprocket 234 to the powered sprocket 232.

The return path 244 of the chain 240 has two portions, a guided portion 248 and a catenary 250. The guided portion 248 may include a conventional chain guide used on curved conveyors, however, the chain guide does not extend to the powered sprocket 232 as it does with conventional conveyors. Rather, the guided portion 248 is shorter than the return path 244, so that the chain 240 can sag and form the catenary 250. As shown in FIG. 5A, the chain 240 does not have to be pulled tight between the sprockets 232, 234 because it is maintained tight enough to operate by the catenary 250. The length of the guided portion 248 can be changed to change the length of the catenary 250, which is a design choice of the conveyor 230. It is noted that even a small catenary 250 requires the chain 240 to follow the arc or curve of the conveyor 240 as shown in FIG. 4.

Another embodiment of a conveyor 280 is shown in FIG. 5B. The conveyor 280 may be identical to the conveyor 230 of FIG. 5A except for the return path 244. The return path 244 of the conveyor 280 has at least one roller and/or guide that contacts the chain 240 in the return path 244. The embodiment of the conveyor 280 has three supports or rollers 281 that are referred to individually as a first roller 282, a second roller 284, and a third roller 286. Although, three rollers 281 are shown in FIG. 5B, fewer or more rollers may be used in the conveyor 280. The rollers 281 may be sprockets and may have cogs (not shown) that engage the chain 240 in a conventional manner. The rollers 281 may also be guides or the like that guide the chain 240.

The use of the rollers 281 enables the conveyor 280 to guide the chain 240 somewhat during its return path. The rollers 281 also prevent the chain 240 from sagging too far and interfering with other components of the conveyor 280 or other components in the vicinity of the conveyor 280. As shown in FIG. 5B, the use of three rollers 281 creates four catenary portions 290, which are referred to individually as a first catenary 292, a second catenary 294, a third catenary 296, and a fourth catenary 298. The use of the rollers 281 and the catenaries 290 may cause less wear on the chain 240 and other components in the conveyor 280 because there is less friction on the rollers 281 than there typically is on a chain guide.

FIG. 5C shows an embodiment of a conveyor 300 that is similar to the conveyor 280 of FIG. 5B. The conveyor 300 has at least one slide or guide in the return path 244 of the chain 240. The embodiment of FIG. 5C has three slides 304 that are referred to individually as the first slide 306, the second slide 308, and the fourth slide 310. The slides 304 enable the chain 240 to slide in order to be guided in the return path 244. The slides 304 may be quieter than the rollers 281, but they may wear faster. The use of three slides 304 forms four catenaries 314 that are referred to individually as the first catenary 316, the second catenary 318, the third catenary 320, and the fourth catenary 322.

A conveyor 330 with no guides or supports in the return path 244 of the chain 240 is shown in FIG. 5D. The lack of guides and supports causes a single catenary 334 to be formed in the return path 244. The weight of the chain 240 pulls the chain 240 tight enough to operate effectively in the conveyor 330.

The use of the catenaries in the conveyors of FIGS. 5A-5D enable the conveyors to operate without a user adjusting the tension of the chain 240. Therefore, a user may operate the conveyors without moving the rollers 232, 234. In addition, without excessive tension being applied to the chain 240, the chain 240 and its associated components are less likely to wear prematurely. The catenaries described above also enable the chain to stretch without affecting the operation of the conveyor. For example, during the life of a chain, it may stretch. Conventional conveyors require adjustments to take up the slack created by the stretched chain. The catenaries described herein take up the slack by their sag, so no adjustment is necessary.

While illustrative and presently preferred embodiments of the invention have been described in detail herein, it is to be understood that the inventive concepts may be otherwise variously embodied and employed and that the appended claims are intended to be construed to include such variations except insofar as limited by the prior art.

What is claimed is:

1. A curved conveyor comprising:
a first end wherein items to be conveyed are received onto the conveyor at the first end;
a second end wherein the items to be conveyed are removed from the conveyor at the second end, wherein the conveyor forms an arc between the first end and the second end;
a continuous belt rotatable between the first end and the second end along the arc of the conveyor, the belt having a forward path during its travel from the first end to the second end, and wherein the belt has a return path during its travel from the second end to the first end;
a chain attached to the belt, wherein the chain forms a catenary in at least a portion of the return path.

2. The conveyor of claim 1, wherein the catenary forms at least ten percent of the return path of the chain.

3. The conveyor of claim 1, wherein the chain forms a plurality of catenaries in the return path.

4. The conveyor of claim 1, wherein the chain forms a catenary in substantially the entire length of the return path.

5. The conveyor of claim 1, wherein the chain forms a catenary in the entire return path.

6. The conveyor of claim 1, wherein the chain forms two catenaries in the return path, the two catenaries being separated by a chain guide.

7. The conveyor of claim 1, wherein the chain forms two catenaries in the return path, the two catenaries being separated by a roller.

8. The conveyor of claim 1, wherein the return path of the chain has a first portion and a second portion, the first portion being supported by a chain guide, the second portion forming a catenary.

9. The conveyor of claim 1, wherein the catenary follows the curve of the conveyor.

10. A method of operating a curved conveyor, the conveyor comprising a chain attached to a belt, the chain and belt having a forward path and a return path, the method comprising providing a catenary for the chain in the return path, the catenary at least partially extending along the curve.

11. The method of claim 10, wherein the providing a catenary for the chain in the return path comprises providing a catenary in at least ten percent of the return path of the chain.

12. The method of claim 10, wherein the providing a catenary for the chain in the return path comprises providing a plurality of catenaries in the return path.

13. The method of claim 10, wherein the providing a catenary for the chain in the return path comprises providing a catenary in substantially the entire length of the return path.

14. The method of claim 10, wherein the providing a catenary for the chain in the return path comprises providing a catenary in the entire return path.

15. The method of claim 10, wherein the providing a catenary for the chain in the return path comprises providing two catenaries in the return path, the two catenaries being separated by a chain guide.

16. The method of claim 10, wherein the providing a catenary for the chain in the return path comprises providing two catenaries in the return path, the two catenaries being separated by a roller.

17. The method of claim 10, wherein the return path of the chain has a first portion and a second portion, the first portion being supported by a chain guide, the second portion forming the catenary.
